(19) United States
(12) Patent Application Publication
(10) Pub. No.: US 2024/0172738 A1
(43) Pub. Date: May 30, 2024

(54) POISON DEPOSITING TOOL FOR TUNNELING OR BURROWING PESTS

(71) Applicant: Sody Lay, Laguna Niguel, CA (US)

(72) Inventor: Sody Lay, Laguna Niguel, CA (US)

(21) Appl. No.: 18/058,852

(22) Filed: Nov. 25, 2022

(51) Int. Cl. A01M 25/00

(52) U.S. Cl. CPC A01M 25/006

(57) ABSTRACT

A poison depositing tool is provided for tunneling and burrowing pests, comprising: a) a rod comprising a first end, a second end, and a plunger; b) a distribution tube comprising a first opening and a second opening defining an interior hollow space configured to enable the rod to be inserted into the interior hollow space such that the plunger substantially fills a portion of the interior hollow space proximal to the second opening; and c) a lid configured to fit atop the first opening of the distribution tube and the first end of the rod when the rod is fully inserted into the distribution tube, wherein the lid is further configured to hold the rod in place in the distribution tube when a user pushes the distribution tube into the ground. Methods for depositing poison into a tunnel or burrow of a tunneling or burrowing pest are also provided.

### TECHNICAL FIELD

Aspects described herein relate to a poison depositing tool for tunneling or burrowing pests, particularly gophers, moles, and voles.

### BACKGROUND

Controlling burrowing rodents is a serious problem for farmers and homeowners alike. These pests inflict damage on vegetation and crops, causing substantial losses in both time and resources. For example, gophers live in underground burrows which may include individual tunnels or runs of one-half mile or more in length. A community of gophers can build a labyrinth of such underground runs and reproduce in such numbers over relatively short periods of time that they become severe economic liabilities for persons engaged in many different areas of agriculture.

Many methods have been devised over the years to control burrowing rodents, including either terminating or repelling them. Basic methods of termination include drowning by flooding their burrows, suffocating with poisonous gases, and killing them by placing poison or traps in their tunnels. Methods of repelling rodents include placing dog and cat hair, pepper products, and electric noise makers in their burrows.

Where allowed, killing gophers by placing poison in their tunnels is the most conclusive method. However, tools currently available to dispense poison in rodent tunnels are laborious to use and often not effective. Accordingly, there is a need for improved poison depositing tools for tunneling or burrowing pests, particularly gophers, moles, and voles, without the disadvantages described above.

### SUMMARY

To address the foregoing problems, in whole or in part, and/or other problems that may have been observed by persons skilled in the art, the present disclosure provides compositions and methods as described by way of example as set forth below.

In one embodiment, a poison depositing tool for tunneling or burrowing pests is provided, comprising:
a) a rod comprising a first end, a second end opposite the first end, and a plunger positioned closer to the first end than the second end;
b) a distribution tube comprising a first opening and a second opening opposite one another, wherein the distribution tube, the first opening, and the second opening define an interior hollow space, wherein the first opening is larger than the second opening and the distribution tube is tapered from the first opening to the second opening, wherein the rod and distribution tube are configured to enable the rod to be inserted into the interior hollow space of the distribution tube, and wherein the plunger and the interior hollow space are configured such that the plunger substantially fills a portion of the interior hollow space proximal to the second opening; and
c) a lid configured to fit atop the first opening of the distribution tube and the first end of the rod when the rod is fully inserted into the distribution tube, wherein the lid is further configured to hold the rod in place in the distribution tube when a user pushes the distribution tube into the ground.

In some aspects, the second end of the rod is tapered. In other aspects the distribution tube is funnel-shaped. In further aspects, the tunneling or burrowing pests comprise gophers, moles, and/or voles.

A method is also provided for depositing poison into a tunnel or burrow of a tunneling or burrowing pest comprising the steps of:
i) probing an area of ground with the rod of the poison depositing tool described herein to identify a tunnel or burrow of a tunneling or burrowing pest, wherein the first end is held higher than the second end and the plunger is configured to serve as a handle;
ii) once a tunnel or burrow has been identified, removing the rod from the ground, thereby creating a hole accessing the tunnel or burrow;
iii) inserting the first end of the rod into the first opening of the distribution tube, through the interior hollow space, and out the second opening of the distribution tube, whereby the rod is fully inserted into the distribution tube with the plunger blocking the second opening;
iv) fitting the lid atop the first opening of the distribution tube and the first end of the rod to firmly affix the rod in place in the distribution tube;
v) pushing the tube with the rod firmly affixed by the lid into the hole, whereby the plunger displaces any dirt or debris from entering the interior hollow space as the tube is pushed through the hole and into the tunnel or burrow;
vi) removing the lid and removing the rod from the distribution tube;
vii) depositing poison into the tunnel or burrow through the distribution tube; and
viii) removing the distribution tube from the tunnel or burrow.

Other compositions, methods, features, and advantages of the invention will be or will become apparent to one with skill in the art upon examination of the following figures and detailed description. It is intended that all such additional compositions, methods, features, and advantages be included within this description, be within the scope of the invention, and be protected by the accompanying claims.

### BRIEF DESCRIPTION OF DRAWINGS

Having thus described the subject matter of the present invention in general terms, reference will now be made to the accompanying drawings, which are not necessarily drawn to scale, and wherein:

FIG. 1A shows a rod with a plunger that forms part of the poison depositing tool for tunneling or burrowing pests of the present invention;

FIG. 1B shows the rod of FIG. 1A in an inverted position compared to the view in FIG. 1A;

FIG. 1C shows a distribution tube that forms part of the poison depositing tool of the present invention;

FIG. 1D shows the rod of FIG. 1A inserted into the distribution tube of FIG. 1C; and

FIG. 1E shows a lid configured to fit atop an end of the distribution tube and an end of the rod.

### DETAILED DESCRIPTION

The subject matter of the present invention now will be described more fully hereinafter, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions. Therefore, it is to be understood that the subject matter of the present invention is not to be limited to the specific embodiments disclosed and that modifications and other embodiments are intended to be included within the scope of the appended claims.

### Poison Depositing Tool for Tunneling or Burrowing Pests

The present invention relates to the development of a poison depositing tool for tunneling or burrowing pests, particularly gophers, moles, and voles.

In one embodiment, a poison depositing tool for tunneling or burrowing pests is provided, comprising:
a) a rod comprising a first end, a second end opposite the first end, and a plunger positioned closer to the first end than the second end;
b) a distribution tube comprising a first opening and a second opening opposite one another, wherein the distribution tube, the first opening, and the second opening define an interior hollow space, wherein the first opening is larger than the second opening and the distribution tube is tapered from the first opening to the second opening, wherein the rod and distribution tube are configured to enable the rod to be inserted into the interior hollow space of the distribution tube, and wherein the plunger and the interior hollow space are configured such that the plunger substantially fills a portion of the interior hollow space proximal to the second opening; and
c) a lid configured to fit atop the first opening of the distribution tube and the first end of the rod when the rod is fully inserted into the distribution tube, wherein the lid is further configured to hold the rod in place in the distribution tube when a user pushes the distribution tube into the ground.
   In some aspects, the second end of the rod is tapered. In other aspects the distribution tube is funnel-shaped. In further aspects, the tunneling or burrowing pests comprise gophers, moles, and/or voles.

A method is also provided for depositing poison into a tunnel or burrow of a tunneling or burrowing pest comprising the steps of:
i) probing an area of ground with the rod of the poison depositing tool described herein to identify a tunnel or burrow of a tunneling or burrowing pest, wherein the first end is held higher than the second end and the plunger is configured to serve as a handle;
ii) once a tunnel or burrow has been identified, removing the rod from the ground, thereby creating a hole accessing the tunnel or burrow;
iii) inserting the first end of the rod into the first opening of the distribution tube, through the interior hollow space, and out the second opening of the distribution tube, whereby the rod is fully inserted into the distribution tube with the plunger blocking the second opening;
iv) fitting the lid atop the first opening of the distribution tube and the first end of the rod to firmly affix the rod in place in the distribution tube;
v) pushing the tube with the rod firmly affixed by the lid into the hole, whereby the plunger displaces any dirt or debris from entering the interior hollow space as the tube is pushed through the hole and into the tunnel or burrow;
vi) removing the lid and removing the rod from the distribution tube;
vii) depositing poison into the tunnel or burrow through the distribution tube; and
viii) removing the distribution tube from the tunnel or burrow.

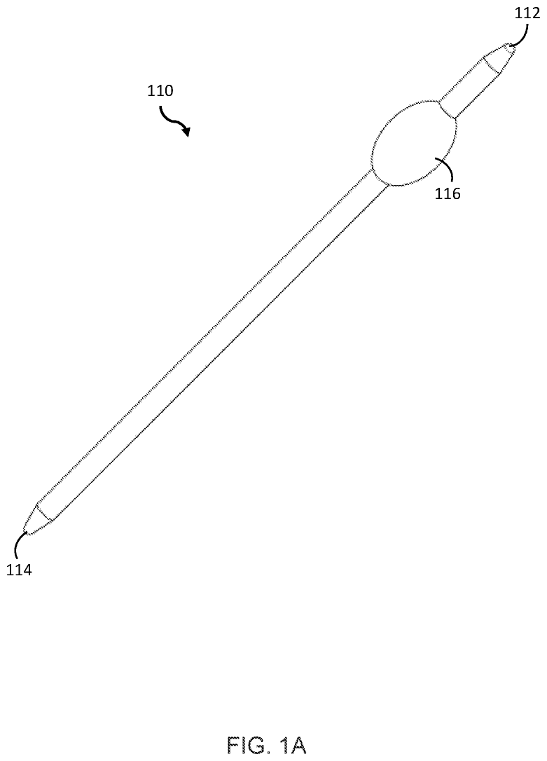

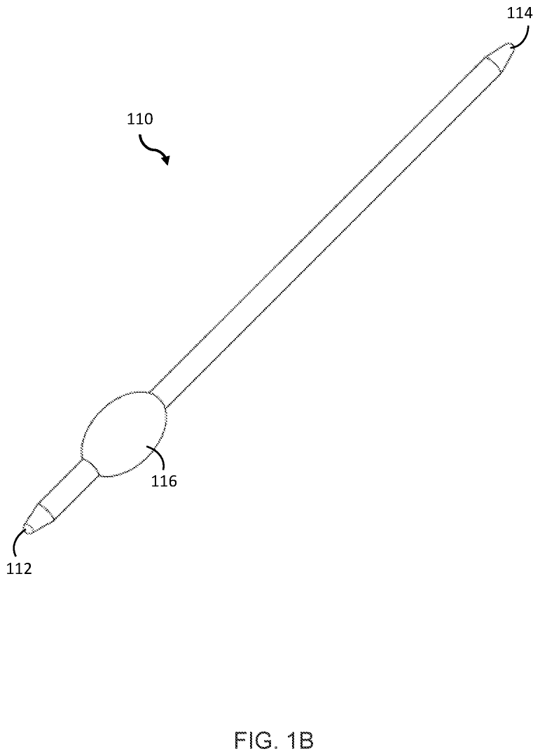

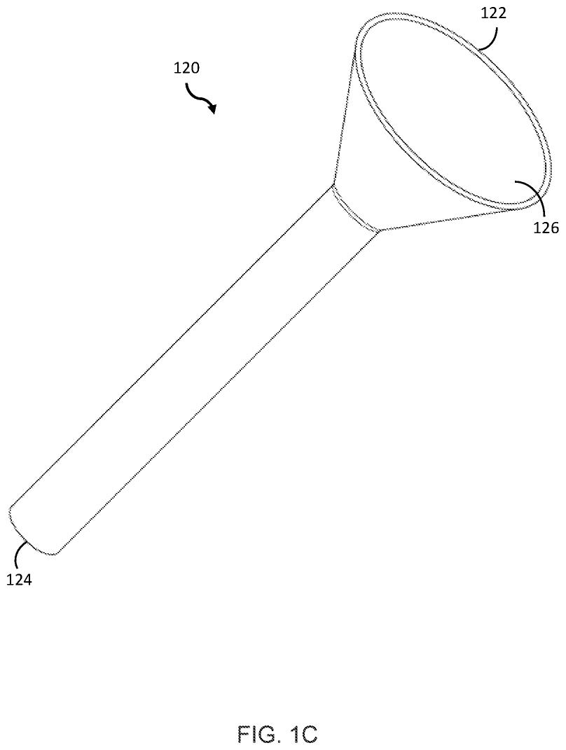

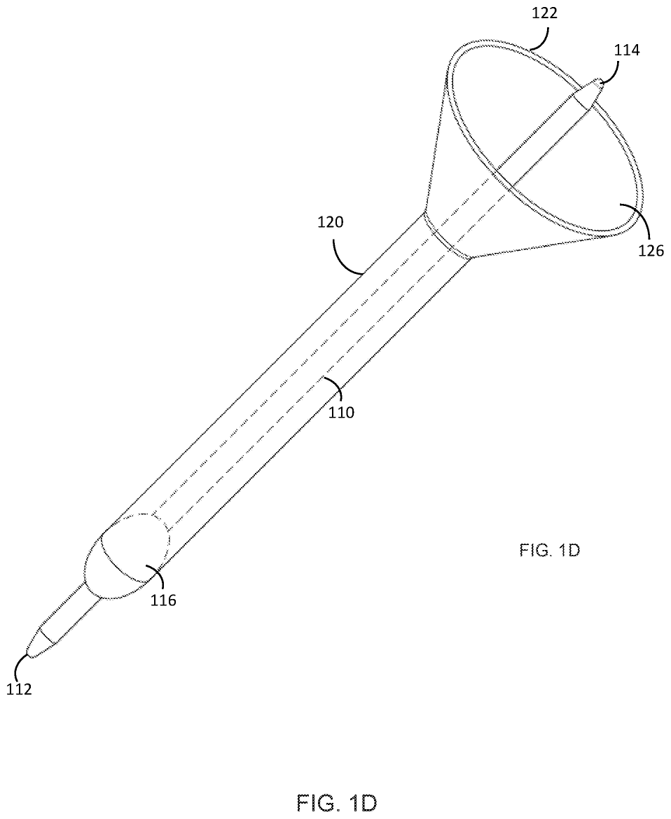

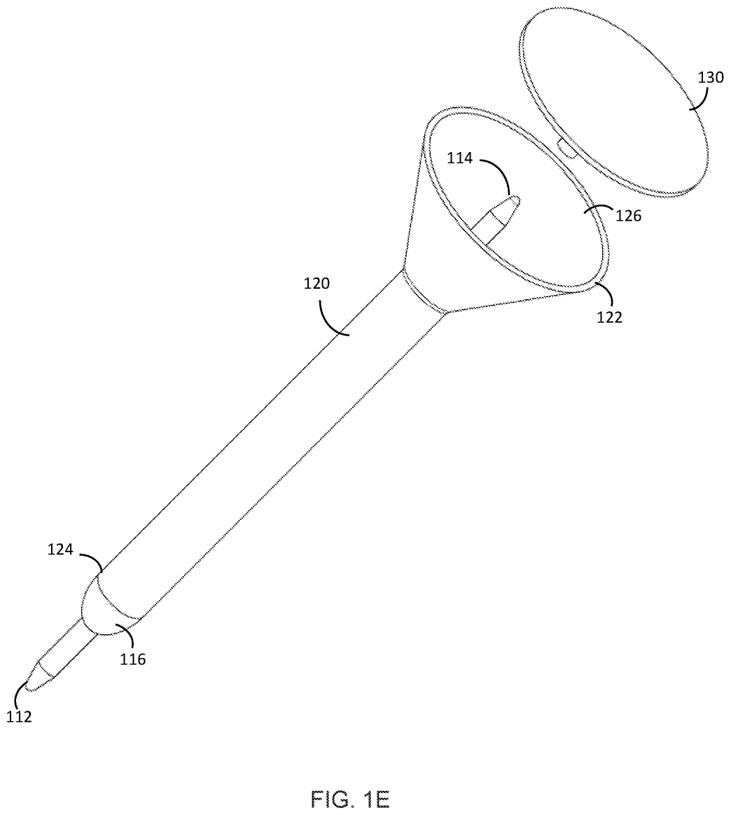

Turning now to FIG. 1A, a rod 110 is shown, comprising a first end 112, a second end 114 opposite the first end, and a plunger 116 positioned closer to the first end than the second end.

Turning now to FIG. 1B, rod 110 is shown in an inverted position compared to the view in FIG. 1A, with first end 112 at the bottom, second end 114 at the top, and plunger 116 positioned closer to the first end than the second end.

Turning now to FIG. 1C, a distribution tube 120 is shown comprising a first opening 122 and a second opening 124 opposite one another, wherein the distribution tube, the first opening, and the second opening define an interior hollow space 126. The first opening is larger than the second opening and the distribution tube is tapered from the first opening to the second opening.

Turning now to FIG. 1D, rod 110 is shown inserted into distribution tube 120. The rod and distribution tube are configured to enable the rod to be inserted into the interior hollow space of the distribution tube, and wherein the plunger and the interior hollow space are configured such that the plunger substantially fills a portion of the interior hollow space proximal to the second opening. Also shown are first end 112, second end 114, plunger 116, distribution tube 120, first opening 122, second opening 124, and hollow space 126.

Turning now to FIG. 1E, a lid 130 is shown configured to fit atop first opening 122 of distribution tube 120, with rod 110 fully inserted into the distribution tube, wherein the first end 112 and plunger 116 are fully or partially out of second opening 124. Second end 114 is visible within interior hollow space 126 defined in part by first opening 122.

### General Definitions

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments±100%, in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

As used herein, the term “substantially free of” refers to less than about 0.01% or less of a substance by weight, particularly about 0.005% or less of a substance by weight, and even more particularly about 0.001% or less of a substance by weight. Alternatively, the term “substantially free of” refers to less than or equal to 20 parts per million (ppm) of a substance, more particularly to less than or equal to 10 ppm of a substance.

### REFERENCE STATEMENT

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

What is claimed is:

1. A poison depositing tool for tunneling or burrowing pests, comprising:
a) a rod comprising a first end, a second end opposite the first end, and a plunger positioned closer to the first end than the second end;
b) a distribution tube comprising a first opening and a second opening opposite one another, wherein the distribution tube, the first opening, and the second opening define an interior hollow space, wherein the first opening is larger than the second opening and the distribution tube is tapered from the first opening to the second opening, wherein the rod and distribution tube are configured to enable the rod to be inserted into the interior hollow space of the distribution tube, and wherein the plunger and the interior hollow space are configured such that the plunger substantially fills a portion of the interior hollow space proximal to the second opening; and
c) a lid configured to fit atop the first opening of the distribution tube and the first end of the rod when the rod is fully inserted into the distribution tube, wherein the lid is further configured to hold the rod in place in the distribution tube when a user pushes the distribution tube into the ground.

2. The poison depositing tool of claim 1, wherein the second end of the rod is tapered.

3. The poison depositing tool of claim 1, wherein the distribution tube is funnel-shaped.

4. The poison depositing tool of claim 1, wherein the tunneling or burrowing pests comprise gophers, moles, and/or voles.

5. A method for depositing poison into a tunnel or burrow of a tunneling or burrowing pest comprising the steps of:
i) probing an area of ground with the rod of the poison depositing tool of claim 1 to identify a tunnel or burrow of a tunneling or burrowing pest, wherein the first end is held higher than the second end and the plunger is configured to serve as a handle;
ii) once a tunnel or burrow has been identified, removing the rod from the ground, thereby creating a hole accessing the tunnel or burrow;
iii) inserting the first end of the rod into the first opening of the distribution tube, through the interior hollow space, and out the second opening of the distribution tube, whereby the rod is fully inserted into the distribution tube with the plunger blocking the second opening;
iv) fitting the lid atop the first opening of the distribution tube and the first end of the rod to firmly affix the rod in place in the distribution tube;
v) pushing the tube with the rod firmly affixed by the lid into the hole, whereby the plunger displaces any dirt or debris from entering the interior hollow space as the tube is pushed through the hole and into the tunnel or burrow;
vi) removing the lid and removing the rod from the distribution tube;
vii) depositing poison into the tunnel or burrow through the distribution tube; and
viii) removing the distribution tube from the tunnel or burrow.
